(19) United States
(12) Patent Application Publication
(10) Pub. No.: US 2017/0009188 A1
(43) Pub. Date: Jan. 12, 2017

(54) SOAP COMPOSITION

(71) Applicant: COSMETIC WARRIORS LIMITED, Poole Dorset (GB)

(72) Inventors: Mark CONSTANTINE, Poole Dorset (GB); Margaret Joan CONSTANTINE, Poole Dorset (GB); Helen Elizabeth AMBROSEN, Wimborne, Dorset (GB)

(21) Appl. No.: 15/115,867

(22) PCT Filed: Feb. 26, 2015
(86) PCT No.: PCT/GB2015/050550

§ 371 Date: Aug. 1, 2016

(30) Foreign Application Priority Data
Feb. 28, 2014 (GB) 1403561.2

(51) Int. Cl. C11D 9/26; C11D 13/16; C11D 13/10; C11D 9/38

(52) U.S. Cl. CPC C11D 9/262; C11D 9/265; C11D 9/38; C11D 13/16; C11D 13/10

(57) ABSTRACT

The use of (i) water, (ii) sugar, sorbitol or a mixture thereof and (iii) humectant is used for improving heat transfer to a soap.

### FIELD OF THE INVENTION

The present invention relates to a use, a soap base for preparing a soap, a process for producing said soap, and a product prepared by the method.

### BACKGROUND TO THE INVENTION

The present invention relates to products particularly those for use in contact with the human body.

The present invention relates to the increasing demand for petrochemical-free cosmetic products. The earliest recorded use of a cosmetic product was in ancient Babylon in 2800BC, where a soap formed from water, cinnamon oil and dissolved ashes was used to wash clothes and prepare wool for weaving. The Egyptians prepared similar soap recipes using animal and vegetable fats, whilst the Greeks utilised ash, water, cypress oil and sesame oil. However it wasn't until AD77 with the publication of the Roman Scientist Pliny the Elder's Historia Naturalis that the word sapo (Latin for soap) was used. The book discusses the manufacture of sapo from tallow and ashes and its application as a hair pomade. But it was the celebrated Roman physician Galen in AD300 who described the use of soap to wash away impurities from the body.

By the 15th century in France the production of soap had been semi-industrialised. In the 16th century there had become a demand for finer soaps and the industry moved away from animal fats towards finer vegetable oils such as olive oil. The use of soap has become universal in industrialized nations due to a better understanding of the role of hygiene in reducing the population size of potential hazardous microorganisms. Industrially manufactured bar soaps first became available in the late 18th century, as advertising campaigns in Europe and the United States promoted popular awareness of the relationship between cleanliness and health.

The chemistry of soap is relatively simple; soap is an ionic compound that is produced along with glycerine from the neutralisation reaction between the fatty acid of a triglyceride and an alkali. The fatty acid source is typically derived from vegetable oils and butter, the blends of butters or oils used in the soap will determine the properties of the soap. For example, oils with high lauric acid (a fatty acid) content such as coconut oil or palm oil will produce a greater amount of soap suds compared to olive oil or cocoa butter which contain only trace levels.

The alkali used in soap manufacture is typically sodium hydroxide (or for liquid soaps potassium hydroxide). The sodium hydroxide is diluted to a 30-50% solution with distilled or deionised water. Distilled/deionised water is used as excessive amounts of heavy metals that may be in the water can disrupt the saponification reaction. The production of this solution is an exothermic reaction. The sodium hydroxide solution is then gently stirred and cooled to between 30° C.-50° C. Once the two phases are at comparable temperatures, the sodium hydroxide solution mixed with the fatty acids. The majority of the saponification reaction is completed with 5-10 minutes. However it can take up to 2 months for the soap to reach a pH (usually 8-8.5) where it is acceptable to be used for cosmetic purposes.

The process discussed above describes the actual manufacture of soap. However that soap can be utilised in the production of more refined and artesian cosmetic soaps. This is a technique known in soap crafting as “melt and pour”. The process differs from that described above as there is no soap made (no actual saponification occurs) in the process. The soap (now referred to as the soap base) is melted and additional items such as fragrance, colorants and texturizing agents may be added. Whilst still warm, the product can poured into moulds which upon cooling can be sliced. In order to melt any soap base effectively a further liquid is necessary, the most commonly used liquid in the manufacture of melt and pour soaps is propylene glycol. In particular, in melt and pour soap system, propylene glycol is used to enhance the transfer of heat from the water through to the soap base, in order to produce a pourable soap that still retains its surfactant properties.

Propylene glycol is an organic compound (C₃H₈O₂) its colourless, clear and viscous liquid derived from the petrochemical industry. Propylene glycol is used in the food, cosmetic and pharmaceutical industries. Propylene glycol is considered ‘generally recognised as safe’ (GRAS) by the FDA and it is used as a humectant, solvent and preservative. However there have been a number of negative reports in the media on the safety of propylene glycol and these reports have been absorbed into the public's consciousness.

Although all the currently peer-reviewed evidence suggests that propylene glycol remains safe, the negative perception remains for many consumers.

The environmental impact of propylene glycol is well documented. In addition to the negative impact of the petrochemical industry propylene glycol is known to exert high level of biochemical oxygen demand during degradation in water systems. This process can adversely affect aquatic life by consuming oxygen aquatic organisms need to survive. Large quantities of dissolved oxygen in water systems are consumed when microorganism decompose propylene glycol. From an environmental point of view it is desirable to reduce the consumption of propylene glycol.

The present invention seeks to provide a soap base and a soap which does not require the use of propylene glycol.

### SUMMARY OF THE INVENTION

In a first aspect, there is provided use of (i) water, (ii) sugar, sorbitol or a mixture thereof and (iii) humectant for improving heat transfer to a soap.

In a second aspect, there is provided a soap base for preparing a solid soap, the soap base comprising

(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) humectant in an amount of from 5 to 40% by weight of the total composition.
wherein the soap base comprises ethanol in an amount of no greater than 5% by weight of the total composition.

In a third aspect, there is provided a process for the production of a soap comprising the steps of

(a) providing a soap base comprising:
(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) humectant in an amount of from 5 to 40% by weight of the total composition
   (b) heating the soap base to a temperature of from greater than 80° C. to less than 100° C., and
   (c) cooling the heated soap base to provide the soap.

In a fourth aspect, there is provided a product obtained or obtainable by a process for the production of a soap comprising the steps of

(a) providing a soap base comprising:
(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) humectant in an amount of from 5 to 40% by weight of the total composition
   (b) heating the soap base to a temperature of from greater than 80° C. to less than 100° C., and
   (c) cooling the heated soap base to provide the soap.

In a fifth aspect, there is provided a solid soap comprising

(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) humectant in an amount of from 5 to 40% by weight of the total composition.
wherein the soap comprises ethanol in an amount of no greater than 5% by weight of the total composition.

The present invention relates to a soap base that may be formed in to a solid soap, typically by the melt and pour process described herein, which does not require the presence of propylene glycol to assist heat transfer when melting the soap. The present soap base provides the user with choice to purchase a soap which does not contain propylene glycol and which has not utilised propylene glycol in its production.

The present invention allows propylene glycol to be eliminated from the melt and pour system. The present invention uses water and sugar, sorbitol or mixture thereof (in the presence of heat and an additional humectant such as glycerine) to create a syrup. During production of melt and pour soaps, heat may be transferred through this syrup to the humectant such as glycerine present in the soap base. This energy transfer allows the saponified fatty acids to be released out of their micelle structure. The saponified heads are attracted to the water content of the syrup, whilst the fatty chain can reside within the sugar/sorbitol content of syrup. This allows the soap to melt and create a composition that can be easily manipulated by the inclusion of additional materials as listed previously. This heat transfer system mimics the effect of propylene glycol within this system without the need for its inclusion.

The avoidance of propylene glycol is advantageous for a number of reasons. In particular, propylene glycol is typically derived from the petroleum industry. Many consumers wish to avoid products which rely on fossil fuels as their source materials. Furthermore we have found that the use of propylene glycol in cosmetics may result in skin sensitisation in the user. The present system provides a soap product which may be formed by the melt and pour process but which avoids the disadvantages of prior art systems, namely skin sensitisation when used.

Thus the present invention advantageously provides a product of a pourable and mouldable soap that requires no propylene glycol for its production. Thus the present invention provides a product which does not require petrochemical derivatives and therefore reduces potentially negative impact on the environment. Furthermore the present invention provides a product which allows for the melt and pour process to be practised while avoiding skin sensitisation.

We have also found that to provide transparent melt and pour soaps in the prior art it has been taught that significant amounts of alcohol such as ethanol must be included in the composition. Ethanol has an irritating or drying effect on the skin of users. Furthermore, the presence of ethanol is unacceptable to many consumers and is a hazard during manufacturing. We have found that soaps may be prepared in accordance with the present invention which have low amounts or preferably are completely free of ethanol.

For ease of reference, these and further aspects of the present invention are now discussed under appropriate section headings. However, the teachings under each section are not necessarily limited to each particular section.

### DETAILED DESCRIPTION

As discussed herein, in one aspect of the present invention, there is provided use of (i) water, (ii) sugar, sorbitol or a mixture thereof and (iii) humectant for improving heat transfer to a soap.

As discussed herein, in one aspect of the present invention, there is provided a soap base for preparing a solid soap, the soap base comprising

(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) humectant in an amount of from 5 to 40% by weight of the total composition.
wherein the soap base comprises ethanol in an amount of no greater than 5% by weight of the total composition.

As discussed herein, in one aspect of the present invention, there is provided a process for the production of a soap comprising the steps of

(a) providing a soap base comprising:
(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) humectant in an amount of from 5 to 40% by weight of the total composition
   (b) heating the soap base to a temperature of from greater than 80° C. to less than 100° C., and
   (c) cooling the heated soap base to provide the soap.

As discussed herein, the soap is a solid soap. Solid products of the present invention are compositions which can substantially sustain their physical shape when unsupported by external means, e.g. packaging etc. Thus, they are considered to be solid, solid like, in solid form or in solid-like form at room temperature. For the avoidance of doubt the solid product must remain substantially solid at up to 30° C.

By solid-like, it is understood that some materials are considered on a day to day basis to be solid, yet over an extremely long period of time, may alter in shape, e.g. amorphous materials such as glass etc. However, they are considered to be solid-like as, for the purpose they fulfil, they are solid. The solid form of the solid compositions of the present invention means that external packaging is not required to maintain the shape of the composition.

As will be understood by one skilled in the art, soap is a salt of fatty acid. Typically the soap of the present invention will be a sodium salt of one or more fatty acids.

As discussed herein, the present invention allows propylene glycol to be eliminated from the melt and pour system. However, while the presence of propylene glycol is to be avoided, its presence will not prevent the action of the present system. In a preferred aspect, propylene glycol is substantially or completely excluded from the present system. Thus in one aspect the soap base contains propylene glycol in amount of from 0 to 1% by weight of the total composition, preferably in amount of from 0 to 0.1% by weight of the total composition, preferably in amount of from 0 to 0.01% by weight of the total composition, preferably in amount of from 0 to 0.001% by weight of the total composition. In one preferred aspect the soap base is substantially free of propylene glycol.

### Soap

In one preferred aspect of the use of the present invention the soap is present in an amount of from 20 to 50% by weight of the total composition.

In one preferred aspect the soap is present in an amount of from 20 to 45% by weight of the total composition. In one preferred aspect the soap is present in an amount of from 20 to 40% by weight of the total composition. In one preferred aspect the soap is present in an amount of from 25 to 50% by weight of the total composition. In one preferred aspect the soap is present in an amount of from 30 to 50% by weight of the total composition. In one preferred aspect the soap is present in an amount of from 33 to 50% by weight of the total composition. In one preferred aspect the soap is present in an amount of from 35 to 50% by weight of the total composition. In one preferred aspect the soap is present in an amount of from 33 to 45% by weight of the total composition. In one preferred aspect the soap is present in an amount of from 35 to 45% by weight of the total composition. In one preferred aspect the soap is present in an amount of from 33 to 38% by weight of the total composition. In one preferred aspect the soap is present in an amount of approximately 38% by weight of the total composition. In one preferred aspect the soap is present in an amount of approximately 33% by weight of the total composition.

The soap present in the compositions described herein may be from any suitable source. In one aspect the soap is saponified vegetable oil or vegetable butter. In one aspect the soap is saponified vegetable oil.

### Water

In one preferred aspect of the use of the present invention water is present in an amount of from 8 to 40% by weight of the total composition.

In one preferred aspect water is present in an amount of from 8 to 35% by weight of the total composition. In one preferred aspect water is present in an amount of from 8 to 30% by weight of the total composition. In one preferred aspect water is present in an amount of from 8 to 25% by weight of the total composition. In one preferred aspect water is present in an amount of from 8 to 20% by weight of the total composition. In one preferred aspect water is present in an amount of from 8 to 16% by weight of the total composition. In one preferred aspect water is present in an amount of approximately 12% by weight of the total composition.

In one preferred aspect water is present in an amount of from 12 to 35% by weight of the total composition. In one preferred aspect water is present in an amount of from 12 to 30% by weight of the total composition. In one preferred aspect water is present in an amount of from 12 to 28% by weight of the total composition. In one preferred aspect water is present in an amount of from 15 to 30% by weight of the total composition. In one preferred aspect water is present in an amount of from 20 to 30% by weight of the total composition. In one preferred aspect water is present in an amount of from 25 to 30% by weight of the total composition. In one preferred aspect water is present in an amount of approximately 28% by weight of the total composition.

The water present in soap or soap base may be provided from any suitable source. In one aspect the water is provided from a source selected from distilled water, deionised water, tap water, plant infusions, plant decoctions (including tea and coffee), fruit juices, vegetable juices, vinegar, beers, wines, spirits and mixtures thereof. In one aspect the water is provided from a source selected from distilled water, deionised water and tap water.

### Sugar/Sorbitol

As discussed herein, the soap base and soap each comprise sugar, sorbitol or a mixture thereof. Thus in one aspect the soap base comprises sugar. In one aspect the soap base comprises sorbitol. In one aspect the soap base comprises sugar and sorbitol.

When sugar is present, sorbitol may or may not be present. In one aspect the soap base and soap each comprise sugar and essentially free of sorbitol. In one aspect the soap base and soap each comprise sorbitol and essentially free of sugar.

In one preferred aspect of the use of the present invention the soap base and soap each comprise sugar, sorbitol or a mixture thereof, wherein the combined amount of sugar and sorbitol is from 2 to 15% by weight of the total composition.

In one preferred aspect the combined amount of sugar and sorbitol is from 5 to 15% by weight of the total composition. In one preferred aspect the combined amount of sugar and sorbitol is from 6 to 12.5% by weight of the total composition. In one preferred aspect the combined amount of sugar and sorbitol is from 7 to 15% by weight of the total composition. In one preferred aspect the combined amount of sugar and sorbitol is from 10 to 15% by weight of the total composition. In one preferred aspect the combined amount of sugar and sorbitol is from 12 to 15% by weight of the total composition. In one preferred aspect the combined amount of sugar and sorbitol is from 5 to 13% by weight of the total composition. In one preferred aspect the combined amount of sugar and sorbitol is from 10 to 15% by weight of the total composition. In one preferred aspect the combined amount of sugar and sorbitol is approximately 12.5% by weight of the total composition. In one preferred aspect the combined amount of sugar and sorbitol is from 2 to 15% by weight of the total composition. In one preferred aspect the combined amount of sugar and sorbitol is from 2 to 12% by weight of the total composition. In one preferred aspect the combined amount of sugar and sorbitol is from 2 to 10% by weight of the total composition. In one preferred aspect the combined amount of sugar and sorbitol is from 4 to 8% by weight of the total composition. In one preferred aspect the combined amount of sugar and sorbitol is from 5 to 7% by weight of the total composition. In one preferred aspect the combined amount of sugar and sorbitol is approximately 6% by weight of the total composition.

In one aspect, the sugar is selected from sucrose, fructose and mixtures thereof. In one aspect, the sugar is sucrose. In one aspect, the sugar is fructose. In one aspect, the sugar is selected from castor sugar, granulated sugar, brown sugar, sucrose powder, fructose powder.

In one preferred aspect the combined amount of sucrose, fructose and sorbitol is from 2 to 15% by weight of the total composition. In one preferred aspect the combined amount of sucrose, fructose and sorbitol is from 5 to 15% by weight of the total composition. In one preferred aspect the combined amount of sucrose, fructose and sorbitol is from 6 to 12.5% by weight of the total composition. In one preferred aspect the combined amount of sucrose, fructose and sorbitol is from 7 to 15% by weight of the total composition. In one preferred aspect the combined amount of sucrose, fructose and sorbitol is from 10 to 15% by weight of the total composition. In one preferred aspect the combined amount of sucrose, fructose and sorbitol is from 12 to 15% by weight of the total composition. In one preferred aspect the combined amount of sucrose, fructose and sorbitol is from 5 to 13% by weight of the total composition. In one preferred aspect the combined amount of sucrose, fructose and sorbitol is from 10 to 15% by weight of the total composition. In one preferred aspect the combined amount of sucrose, fructose and sorbitol is approximately 12.5% by weight of the total composition. In one preferred aspect the combined amount of sucrose, fructose and sorbitol is from 2 to 15% by weight of the total composition. In one preferred aspect the combined amount of sucrose, fructose and sorbitol is from 2 to 12% by weight of the total composition. In one preferred aspect the combined amount of sucrose, fructose and sorbitol is from 2 to 10% by weight of the total composition. In one preferred aspect the combined amount of sucrose, fructose and sorbitol is from 4 to 8% by weight of the total composition. In one preferred aspect the combined amount of sucrose, fructose and sorbitol is from 5 to 7% by weight of the total composition. In one preferred aspect the combined amount of sucrose, fructose and sorbitol is approximately 6% by weight of the total composition.

In one preferred aspect the combined amount of sucrose and sorbitol is from 2 to 15% by weight of the total composition. In one preferred aspect the combined amount of sucrose and sorbitol is from 5 to 15% by weight of the total composition. In one preferred aspect the combined amount of sucrose and sorbitol is from 6 to 12.5% by weight of the total composition. In one preferred aspect the combined amount of sucrose and sorbitol is from 7 to 15% by weight of the total composition. In one preferred aspect the combined amount of sucrose and sorbitol is from 10 to 15% by weight of the total composition. In one preferred aspect the combined amount of sucrose and sorbitol is from 12 to 15% by weight of the total composition. In one preferred aspect the combined amount of sucrose and sorbitol is from 5 to 13% by weight of the total composition. In one preferred aspect the combined amount of sucrose and sorbitol is from 10 to 15% by weight of the total composition. In one preferred aspect the combined amount of sucrose and sorbitol is approximately 12.5% by weight of the total composition. In one preferred aspect the combined amount of sucrose and sorbitol is from 2 to 15% by weight of the total composition. In one preferred aspect the combined amount of sucrose and sorbitol is from 2 to 12% by weight of the total composition. In one preferred aspect the combined amount of sucrose and sorbitol is from 2 to 10% by weight of the total composition. In one preferred aspect the combined amount of sucrose and sorbitol is from 4 to 8% by weight of the total composition. In one preferred aspect the combined amount of sucrose and sorbitol is from 5 to 7% by weight of the total composition. In one preferred aspect the combined amount of sucrose and sorbitol is approximately 6% by weight of the total composition.

In one preferred aspect the combined amount of fructose and sorbitol is from 2 to 15% by weight of the total composition. In one preferred aspect the combined amount of fructose and sorbitol is from 5 to 15% by weight of the total composition. In one preferred aspect the combined amount of fructose and sorbitol is from 6 to 12.5% by weight of the total composition. In one preferred aspect the combined amount of fructose and sorbitol is from 7 to 15% by weight of the total composition. In one preferred aspect the combined amount of fructose and sorbitol is from 10 to 15% by weight of the total composition. In one preferred aspect the combined amount of fructose and sorbitol is from 12 to 15% by weight of the total composition. In one preferred aspect the combined amount of fructose and sorbitol is from 5 to 13% by weight of the total composition. In one preferred aspect the combined amount of fructose and sorbitol is from 10 to 15% by weight of the total composition. In one preferred aspect the combined amount of fructose and sorbitol is approximately 12.5% by weight of the total composition. In one preferred aspect the combined amount of fructose and sorbitol is from 2 to 15% by weight of the total composition. In one preferred aspect the combined amount of fructose and sorbitol is from 2 to 12% by weight of the total composition. In one preferred aspect the combined amount of fructose and sorbitol is from 2 to 10% by weight of the total composition. In one preferred aspect the combined amount of fructose and sorbitol is from 4 to 8% by weight of the total composition. In one preferred aspect the combined amount of fructose and sorbitol is from 5 to 7% by weight of the total composition. In one preferred aspect the combined amount of fructose and sorbitol is approximately 6% by weight of the total composition.

In one preferred aspect the amount of sucrose is from 2 to 15% by weight of the total composition. In one preferred aspect the amount of sucrose is from 5 to 15% by weight of the total composition. In one preferred aspect the amount of sucrose is from 6 to 12.5% by weight of the total composition. In one preferred aspect the amount of sucrose is from 7 to 15% by weight of the total composition. In one preferred aspect the amount of sucrose is from 10 to 15% by weight of the total composition. In one preferred aspect the amount of sucrose is from 12 to 15% by weight of the total composition. In one preferred aspect the amount of sucrose is from 5 to 13% by weight of the total composition. In one preferred aspect the amount of sucrose is from 10 to 15% by weight of the total composition. In one preferred aspect the amount of sucrose is approximately 12.5% by weight of the total composition.

In one preferred aspect the amount of fructose is from 2 to 15% by weight of the total composition. In one preferred aspect the amount of fructose is from 5 to 15% by weight of the total composition. In one preferred aspect the amount of fructose is from 6 to 12.5% by weight of the total composition. In one preferred aspect the amount of fructose is from 7 to 15% by weight of the total composition. In one preferred aspect the amount of fructose is from 10 to 15% by weight of the total composition. In one preferred aspect the amount of fructose is from 12 to 15% by weight of the total composition. In one preferred aspect the amount of fructose is from 5 to 13% by weight of the total composition. In one preferred aspect the amount of fructose is from 10 to 15% by weight of the total composition. In one preferred aspect the amount of fructose is approximately 12.5% by weight of the total composition.

In one preferred aspect the amount of sorbitol is from 2 to 15% by weight of the total composition. In one preferred aspect the amount of sorbitol is from 5 to 15% by weight of the total composition. In one preferred aspect the amount of sorbitol is from 6 to 12.5% by weight of the total composition. In one preferred aspect the amount of sorbitol is from 2 to 15% by weight of the total composition. In one preferred aspect the amount of sorbitol is from 2 to 12% by weight of the total composition. In one preferred aspect the amount of sorbitol is from 2 to 10% by weight of the total composition. In one preferred aspect the amount of sorbitol is from 4 to 8% by weight of the total composition. In one preferred aspect the amount of sorbitol is from 5 to 7% by weight of the total composition. In one preferred aspect the amount of sorbitol is approximately 6% by weight of the total composition.

### Humectant

In one preferred aspect of the use of the present invention the soap base and soap each comprise humectant in an amount of from 5 to 40% by weight of the total composition.

In one preferred aspect the amount of humectant is from 5 to 35% by weight of the total composition. In one preferred aspect the amount of humectant is from 5 to 30% by weight of the total composition. In one preferred aspect the amount of humectant is from 5 to 25% by weight of the total composition. In one preferred aspect the amount of humectant is from 5 to 20% by weight of the total composition. In one preferred aspect the amount of humectant is from 7 to 20% by weight of the total composition. In one preferred aspect the amount of humectant is from 10 to 20% by weight of the total composition. In one preferred aspect the amount of humectant is from 12 to 20% by weight of the total composition. In one preferred aspect the amount of humectant is from 12.5 to 17% by weight of the total composition. In one preferred aspect the amount of humectant is from 5 to 15% by weight of the total composition. In one preferred aspect the amount of humectant is from 7 to 15% by weight of the total composition. In one preferred aspect the amount of humectant is from 10 to 15% by weight of the total composition. In one preferred aspect the amount of humectant is from 12 to 15% by weight of the total composition. In one preferred aspect the amount of humectant is from 5 to 13% by weight of the total composition. In one preferred aspect the amount of humectant is from 10 to 15% by weight of the total composition. In one preferred aspect the amount of humectant is approximately 12.5% by weight of the total composition. In one preferred aspect the amount of humectant is from 10 to 25% by weight of the total composition. In one preferred aspect the amount of humectant is from 10 to 22% by weight of the total composition. In one preferred aspect the amount of humectant is from 15 to 20% by weight of the total composition. In one preferred aspect the amount of humectant is approximately 17% by weight of the total composition.

It is appreciated by skilled in the art that sorbitol may be considered to be a humectant. If sorbitol is used as humectant in the present invention, the amount of components (iii) and (iv) are to be considered separately. That is, some amount of sorbitol may be considered to count towards the requirement of (iii) sugar, sorbitol or a mixture thereof, wherein the combined amount of sugar and sorbitol is from 2 to 15% by weight of the total composition, and the remainder of the amount of sorbitol may be considered to count towards (iv) humectant in an amount of from 5 to 40% by weight of the total composition.

In one aspect, the humectant is a humectant other than sorbitol. In one aspect, the humectant is selected from honey, glycerine, agave nectar, fruit syrups, herbal syrups and mixtures thereof. Preferably the humectant is selected from honey, glycerine and mixtures thereof.

In one aspect, all reference herein to humectant are to be replaced by honey, glycerine and mixtures thereof.

In one preferred aspect the combined amount of honey and glycerine is from 5 to 40% by weight of the total composition. In one preferred aspect the combined amount of honey and glycerine is from 5 to 35% by weight of the total composition. In one preferred aspect the combined amount of honey and glycerine is from 5 to 30% by weight of the total composition. In one preferred aspect the combined amount of honey and glycerine is from 5 to 25% by weight of the total composition. In one preferred aspect the humectant is selected from honey, glycerine and mixtures thereof. In this aspect preferably the combined amount of honey and glycerine is from 5 to 20% by weight of the total composition. In one preferred aspect the combined amount of honey and glycerine is from 7 to 20% by weight of the total composition. In one preferred aspect the combined amount of honey and glycerine is from 10 to 20% by weight of the total composition. In one preferred aspect the combined amount of honey and glycerine is from 12 to 20% by weight of the total composition. In one preferred aspect the combined amount of honey and glycerine is from 12.5 to 17% by weight of the total composition. In one preferred aspect the combined amount of honey and glycerine is from 5 to 15% by weight of the total composition. In one preferred aspect the combined amount of honey and glycerine is from 7 to 15% by weight of the total composition. In one preferred aspect the combined amount of honey and glycerine is from 10 to 15% by weight of the total composition. In one preferred aspect the combined amount of honey and glycerine is from 12 to 15% by weight of the total composition. In one preferred aspect the combined amount of honey and glycerine is from 5 to 13% by weight of the total composition. In one preferred aspect the combined amount of honey and glycerine is from 10 to 15% by weight of the total composition. In one preferred aspect the combined amount of honey and glycerine is approximately 12.5% by weight of the total composition. In one preferred aspect the combined amount of honey and glycerine is from 10 to 25% by weight of the total composition. In one preferred aspect the combined amount of honey and glycerine is from 10 to 22% by weight of the total composition. In one preferred aspect the combined amount of honey and glycerine is from 15 to 20% by weight of the total composition. In one preferred aspect the combined amount of honey and glycerine is approximately 17% by weight of the total composition.

In one preferred aspect the amount of honey is from 5 to 40% by weight of the total composition. In one preferred aspect the amount of honey is from 5 to 35% by weight of the total composition. In one preferred aspect the amount of honey is from 5 to 30% by weight of the total composition. In one preferred aspect the amount of honey is from 5 to 25% by weight of the total composition. In one preferred aspect the humectant is selected from honey, glycerine and mixtures thereof. In this aspect preferably the amount of honey is from 5 to 20% by weight of the total composition. In one preferred aspect the amount of honey is from 7 to 20% by weight of the total composition. In one preferred aspect the amount of honey is from 10 to 20% by weight of the total composition. In one preferred aspect the amount of honey is from 5 to 15% by weight of the total composition. In one preferred aspect the amount of honey is from 7 to 15% by weight of the total composition. In one preferred aspect the amount of honey is from 10 to 15% by weight of the total composition. In one preferred aspect the amount of honey is approximately 12.5% by weight of the total composition.

In one preferred aspect the amount of glycerine is from 5 to 40% by weight of the total composition. In one preferred aspect the amount of glycerine is from 5 to 35% by weight of the total composition. In one preferred aspect the amount of glycerine is from 5 to 30% by weight of the total composition. In one preferred aspect the amount of glycerine is from 5 to 25% by weight of the total composition. In one preferred aspect the humectant is selected from honey, glycerine and mixtures thereof. In one preferred aspect the amount of glycerine is from 10 to 25% by weight of the total composition. In one preferred aspect the amount of glycerine is from 10 to 20% by weight of the total composition. In one preferred aspect the amount of glycerine is from 12 to 20% by weight of the total composition. In one preferred aspect the amount of glycerine is from 10 to 22% by weight of the total composition. In one preferred aspect the amount of glycerine is from 15 to 20% by weight of the total composition. In one preferred aspect the amount of glycerine is approximately 17% by weight of the total composition.

Thus in one aspect there is provided a soap base for preparing a solid soap, the soap base comprising

(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) honey, glycerine or a mixture thereof, wherein the combined amount of honey and glycerine is from 5 to 40% by weight of the total composition;
wherein the soap base comprises ethanol in an amount of no greater than 5% by weight of the total composition.

As discussed herein, the present invention allows ethanol to be eliminated from the melt and pour system. However, while the presence of ethanol is to be avoided, its presence will not prevent the action of the present system. In a preferred aspect, ethanol is substantially or completely excluded from the present system. Thus in one aspect the soap base contains ethanol in amount of from 0 to 1% by weight of the total composition, preferably in amount of from 0 to 0.1% by weight of the total composition, preferably in amount of from 0 to 0.01% by weight of the total composition, preferably in amount of from 0 to 0.001% by weight of the total composition. In one preferred aspect the soap base is substantially free of ethanol.

### Further Components

The soap base or soap may contain one or more additional components such as to provide the desired composition. In one aspect the soap base or soap further comprising at least one additional component selected from surfactants, oils, butters, waxes, fruits, vegetables, clays, herbs, cereals, beans, proteins, binders, fillers, opacifiers, perfumes, colours, fragrances, scrubs, exfoliants and mixtures thereof.

In one aspect the soap base or soap further comprises additional surfactants. Additional surfactants may be selected from sodium lauryl sulfate, sodium laureth sulfate, ammonium lauryl sulfate, ammonium laureth sulfate, sodium cocoamphoacetate, disodium laureth sulfosuccinate, and lauryl betaine. If present, the additional surfactants may be present in an amount of from 4 to 35% by weight of the total composition.

In one aspect the soap base or soap further comprises oil, butter, waxes or mixtures thereof. Oil, butter and waxes may be selected from almond oil, sesame oil, evening primrose oil, jojoba oil, cocoa butter, shea butter, mango butter, cupuacu butter, lanolin, beeswax, rose wax and orange peel wax. If present, the oil, butter and waxes may be present in a combined amount of from 10 to 70% by weight of the total composition.

In one aspect the soap base or soap further comprises fruits and vegetables. Fruits and vegetables may be selected from avocado, banana, strawberries and blueberries, if present, the fruits and vegetables may be present in a combined amount of from 0.5 to 10% by weight of the total composition.

In one aspect the soap base or soap further comprises a fragrance. If present, fragrance may be present in an amount of from 0.1 to 5% by weight of the total composition. Fragrance may be added to the product to make the experience of using the present composition more pleasant. Combining essential oils such as lavender, chamomile or rose absolute into fragrances for the invention ensures the user has a pleasant washing experience. The amount of fragrances is preferably from 0.1% to 5% by weight of the total composition, such as from 0.1% to 4% by weight of the total composition, such as from 0.5% to 5% by weight of the total composition, such as from 1% to 5% by weight of the total composition, such as from 0.5% to 4% by weight of the total composition, such as from 0.5% to 3% by weight of the total composition, such as from 0.5% to 2% by weight of the total composition, such as from 0.5% to 1.5% by weight of the total composition.

The essential oils may be selected based on the fragrance desired, skin type to be treated and other effects desired based on the well-known properties of essential oils. The addition of essential oils, when taken in to the nose, is known to alter mood. For example, essential oils are known to create effects of drowsiness or stimulating the senses. Many well documented effects can be achieved by the use of essential oils.

In one embodiment, the one or more essential oils present in the product are selected from Tarragon, Lemon myrtle, Jasmin, Ylang ylang, Labdanum, Lemongrass, Rose otto, Grapefruit, Patchouli, Rosemary, Armois, Lemon, Neroli, Sweet violet, Lavender, Orange 50 fold, Vanilla, Peppermint, Benzoin, Hydrangea, Litsea Cubeba, Cardamon, Tonka, and Chamomile blue. In one embodiment, the one or more essential oils present in the product are selected from Tarragon, Lemon myrtle, Labdanum, and Lemongrass.

Vitamins, particularly B, C and E are very beneficial for the skin. Vitamin rich ingredients such as Wheatgerm oil can also be used to deliver vitamins on to the skin. In a one embodiment, the vitamins are selected from vitamin B, vitamin C, vitamin E and mixtures thereof. It will be appreciated by one skilled in the art that the vitamin may be provided from any suitable source. For example the vitamin(s) may be provided from a synthetic source or from incorporation into the product of a material, such as a natural material, that has a high vitamin content.

In one aspect the soap base or soap further comprises a colorant material. If present, colorant materials may be present in an amount of from 0.001 to 3% by weight of the total composition.

In one aspect the soap base or soap further comprises a clay. The clay may be selected from all suitable clays. Preferably the clay is selected from kaolin, talc, calamine, rhassoul mud, fullers earth, bentonite clays and mixtures thereof. If present, the clay may be present in an amount of from 0.1 to 35% by weight of the total composition, such as in an amount of from 0.1 to 20% by weight of the total composition.

In one aspect the soap base or soap further comprises herbs, cereals, beans or mixtures thereof. Preferably the herbs, cereals, beans or mixtures thereof are selected from oats, rice, cinnamon, vanilla, aduki beans, seaweeds and mixtures thereof. If present, the herbs, cereals, beans or mixtures may be present a combined amount of from 0.01 to 35% by weight of the total composition, such as in a combined amount of from 0.01 to 30% by weight of the total composition.

In one aspect the cosmetic composition further comprises a protein. The protein may be selected from all suitable proteins. Preferably the protein is selected tofu, banana, soya, soya lecithin, eggs and mixtures thereof. If present, the protein may be present in an amount of from 1% to 20% by weight of the total composition.

### Process

As discussed herein, in one aspect the present invention provides a process for the production of a soap comprising the steps of

(a) providing a soap base comprising:
(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) humectant in an amount of from 5 to 40% by weight of the total composition
   (b) heating the soap base to a temperature of from greater than 80° C. to less than 100° C., and
   (c) cooling the heated soap base to provide the soap.

In the aspect that component (iii) is sugar, a preferred composition is prepared as follows

| | Weight % | Raw Material Type |
|---|---|---|
| A | 8%-40% | Water/Juices/Infusion/Decoction |
| | 2%-15% | Sugar |
| | 5%-40% | Humectant |
| B | 20%-50% | Soap Base |
| C | 0.1%-5% | Fragrance |
| | 0.001%-3% | Colour |
| | 0.1%-30% | Texturising Materials |

In the aspect that component (iii) is sorbitol, a preferred composition is prepared as follows

| | Weight % | Raw Material Type |
|---|---|---|
| A | 8%-40% | Water/Juices/Infusion/Decoction |
| | 2%-15% | Sorbitol |
| | 5%-40% | Humectant |
| B | 20%-50% | Soap Base |
| C | 0.1%-5% | Fragrance |
| | 0.001%-3% | Colour |
| | 0.1%-30% | Texturising Materials |
| | 0.000 | |

The components of either composition are processed in accordance with the following method:

1. Warm A to between 65° C.-95° C. With the ideal temperature being 85° C.
2. Gradually add the B to A whilst maintaining the temperature
3. Whisk the AB together until all the soap base has melted
4. Cool the AB to between 60° C.-30° C., with the ideal temperature being 35° C.
5. Add C. Then pour into moulds, cool to set.

### Further Aspects

In further aspects the present invention provides:

A soap base for preparing a solid soap, the soap base comprising

(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) humectant in an amount of from 5 to 40% by weight of the total composition.

A process for the production of a soap comprising the steps of

(a) providing a soap base comprising:
(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) humectant in an amount of from 5 to 40% by weight of the total composition
   (b) heating the soap base, and
   (c) cooling the heated soap base to provide the soap.

A soap product obtained or obtainable by a process comprising the steps of

(a) providing a soap base comprising:
(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) humectant in an amount of from 5 to 40% by weight of the total composition
   (b) heating the soap base, and
   (c) cooling the heated soap base to provide the soap.

A soap product obtained or obtainable from a soap base comprising

(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) humectant in an amount of from 5 to 40% by weight of the total composition.

A solid soap comprising

(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) humectant in an amount of from 5 to 40% by weight of the total composition.

### EXAMPLES

The invention will now be described with reference to the following non-limiting examples in which:

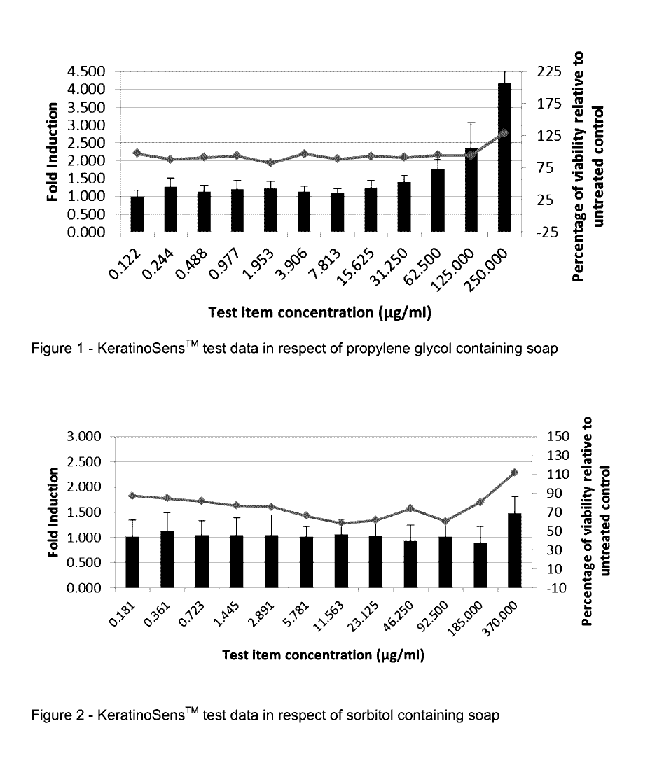

FIG. 1 shows a graph of skin sensitivity data; and

FIG. 2 shows a graph of skin sensitivity data.

### Example 1

### Sugar Based Soap Base

The following sugar based soap base was prepared. The soap base had the following composition

| | | Batch Size (g) | 1000.00 |
|---|---|---|---|
| | Weight % | Raw Material Type | (g) |
| A | 12.00 | Water | 120.000 |
| | 12.50 | Granulated Sugar | 125.000 |
| | 12.50 | Honey | 125.000 |
| B | 38.00 | Soap (saponified vegetable oil) | 380.000 |
| C | 4.00 | Fragrance | 40.000 |
| | 1.00 | Colour | 10.000 |
| | 10.00 | Corn flour | 100.000 |
| | 5.00 | Oatmeal | 50.000 |
| | 5.00 | Soya Milk | 50.000 |
| | 100.000 | | 1000.000 |

### Method

### 1. Warm A to 85° C.

2. Gradually add the B to A whilst maintaining the temperature
3. Whisk the AB together until all the soap base has melted

### 4. Cool the AB to 35° C.

5. Add C. Then pour into moulds, cool to set.

During the preparation method, heat was readily transferred to the soap (saponified vegetable oil) which resulted in easy dispersion of the components.

### Example 2

### Sorbitol Based Soap Base

The following sorbitol based soap base was prepared. The soap base had the following composition

| | | Batch Size (g) | 1000.00 |
|---|---|---|---|
| | Weight % | Raw Material Type | (g) |
| A | 28.50 | Water | 285.000 |
| | 6.00 | Sorbitol Powder | 60.000 |
| | 17.50 | Glycerine | 175.000 |
| B | 33.00 | Soap Base (saponified | 330.000 |
| | | vegetable oil) | |
| C | 4.00 | Fragrance | 40.000 |
| | 1.00 | Colour | 10.000 |
| | 10.00 | Orange Juice | 100.000 |
| | 100.000 | | 1000.000 |

The method of example 1 was utilised.

During the preparation method, heat was readily transferred to the soap (saponified vegetable oil) which resulted in easy dispersion of the components.

### Example 3

### Skin Sensitisation

### Methods

The KeratinoSens™ test detects the potential of the test item to activate cells known as keratinocytes, which are derived from the epidermis of human skin. A specialised gene for a marker called luciferase has been inserted into the cells. In the presence of a skin sensitiser, luciferase is activated and causes the emission of a light signal, which is measured in the test. Induction of luciferase activity by >1.5-fold above untreated controls results in classification as a skin sensitiser.

The Direct Peptide Reactivity Assay (DPRA) measures the potential of a test item to bind to two building blocks of skin proteins called cysteine and lysine. The test item is dissolved in an appropriate solvent and incubated with cysteine or lysine for 24 hours.

Peptide depletion is measured by High Performance Liquid Chromatography (HPLC). The percentage depletion value determines the reactivity class of the test item as minimal, low, moderate or high. The minimal reactivity class results in a prediction that the test item is a non-sensitiser; the low, moderate or high reactivity classes result in a prediction that the test item is a skin sensitiser.

Skin sensitisation is a complex pathway of events, leading to inflammation. It is often associated with repeat exposure during long term use of a cosmetic product, during which an individual can become sensitised to one or more ingredients within the formulation. The human skin sensitisation potential of two soaps were assessed using two validated in vitro methods, looking at two different points in the sensitisation pathway: the Direct Peptide Reactivity assay (DPRA) to determine skin protein binding, and the KeratinoSens™ test to determine keratinocyte activation.

The two soaps tested were (i) a sorbitol based soap prepared in accordance with Example 2 and (ii) an analogous soap in which propylene glycol was used in place of the sorbitol.

The combined use of these two tests is in line with current recommendations from the European Centre for the Validation of Alternative Methods (ECVAM). At the time these compositions were assessed the test methods were draft OECD Guidelines. However the KeratinoSens™ and DPRA guidelines have subsequently been approved by the OECD for the in chemico and in vitro skin sensitivity assessment of chemical entities (KeratinoSens™: ‘OECD Testing Guidelines 442D’ and DPRA: ‘OECD Testing Guidelines 442C’). It is expected that these guidelines are to be incorporated into REACH by 2016.

These tests were performed in XCellR8's GLP (Good Laboratory Practice) accredited laboratory without the use of any animal-derived components, ensuring a fully animal-free testing strategy.

In the DPRA test, propylene glycol containing soap was classified as a non-sensitiser to human skin. However, in the KeratinoSens™ test, the propylene glycol containing soap was classified as a skin sensitiser. Overall, the test results suggest that the propylene glycol containing soap may have some sensitisation potential through the activation of human skin cells (keratinocytes), which may result in inflammation in susceptible individuals.

In contrast, in both the DPRA test and the KeratinoSens™ test, the sorbitol based soap was classified as a non-sensitiser to human skin.

The DPRA data is provided in the table below

| | | | Mean % Cysteine |
|---|---|---|---|
| | Cysteine % | Lysine % | and Lysine |
| Test Item | Depletion | Depletion | Depletion |
| Sorbitol based soap | 1.0% | 0% | 0.5 |
| Propylene glycol | 3.8% | 0% | 1.9% |
| based soap | | | |

The KeratinoSens™ test data can be seen in FIGS. 1 and 2.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, biology or related fields are intended to be within the scope of the following claims.

1. A composition comprising (i) water, (ii) sugar, sorbitol or a mixture thereof and (iii) humectant having improved heat transfer to a soap.

2. The composition according to claim wherein the (i) water, (ii) sugar, sorbitol or a mixture thereof and (iii) humectant are in contact in a soap base, wherein the soap base comprises soap in an amount of from 20 to 50% by weight of the soap base.

3. The compositions according to claim 2, wherein the soap is present in an amount of from 35 to 45% by weight of the total composition.

4. The soaps according to claim 2, wherein soap is present in an amount of approximately 38% by weight of the total composition.

5. The composition according to claim 1, wherein the soap is saponified vegetable oil or butter.

6. The composition according to claim 1, wherein the (i) water, (ii) sugar, sorbitol or a mixture thereof and (iii) humectant are in contact in a soap base, wherein the soap base comprises:
(i) water in an amount of from 8 to 40% by weight of the soap base.

7. The compositions according to claim 6, wherein water is present in an amount of from 8 to 16% by weight of the total composition.

8. The compositions according to claim 6, wherein water is present in an amount of approximately 12% by weight of the total composition.

9. The composition according to claim 1, wherein the water is provided by a source selected from distilled water, deionised water, tap water, plant infusions, plant decoctions (including tea and coffee), fruit juices, vegetable juices, vinegar, beers, wines, spirits and mixtures thereof.

10. The composition according to claim 1, wherein the (i) water, (ii) sugar, sorbitol or a mixture thereof and (iii) humectant are in contact in a soap base, the soap base comprising:
(ii) sugar, sorbitol or a mixture thereof, wherein the combined amount of sugar and sorbitol is from 2 to 15% by weight of the total composition.

11. The composition according to claim 10, wherein the combined amount of sugar and sorbitol is from 5 to 15% by weight of the total composition.

12. The composition according to claim 10, wherein the combined amount of sugar and sorbitol is from 6 to 12.5% by weight of the total composition.

13. The composition according to claim 1, wherein the soap base comprises sugar.

14. The composition according to claim 1, wherein the sugar is selected from castor sugar, granulated sugar, brown sugar, sucrose powder, fructose powder.

15. The composition according to claim 1, wherein the sugar is selected sucrose and fructose.

16. The composition according to claim 1, wherein the sugar is sucrose.

17. The composition according to any one of the claim 1, wherein the soap base comprises sorbitol.

18. The composition according to any one of the claim 1, wherein the soap base comprises sugar and sorbitol.

19. The composition according to any one of the claim 1, wherein the (i) water, (ii) sugar, sorbitol or a mixture thereof and (iii) humectant are in contact in a soap base, the soap base comprising:
(iii) humectant in an amount of from 5 to 40% by weight of the soap base.

20. The composition according to claim 19, wherein humectant is present in an amount of from 10 to 20% by weight of the total composition.

21. The compositions according to claim 19, wherein humectant is present in an amount of from 12.5 to 17% by weight of the total composition.

22. The composition according to claim 1, wherein the humectant is selected from honey, glycerine, agave nectar, fruit syrups, herbal syrups and mixtures thereof.

23. The composition according to claim 1, wherein the humectant is selected from honey, glycerine and mixtures thereof.

24. The composition according to claim 1, wherein the soap base contains propylene glycol in amount of from 0 to 0.01% by weight of the total composition.

25. The composition according to claim 1, wherein the soap base is substantially free of propylene glycol.

26. The composition according to claim 1, further comprising at least one additional component selected from surfactants, oils, butters, waxes, fruits, vegetables, clays, herbs, cereals, beans, proteins, binders, fillers, opacifiers, perfumes, colours, fragrances, scrubs, exfoliants and mixtures thereof.

27. The compositions according to claim 1, wherein the water, sugar, humectant and soap are in contact in a soap base, the soap base comprising:
(i) soap in an amount of from 20 to 50% by weight of the soap base,
(ii) water in an amount of from 8 to 40% by weight of the soap base,
(iii) sugar, sorbitol or a mixture thereof, wherein the combined amount of sugar and sorbitol is from 2 to 15% by weight of the total composition, and
(iv) humectant in an amount of from 5 to 40% by weight of the soap base.

28. A soap base for preparing a solid soap, the soap base comprising:
(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) humectant in an amount of from 5 to 40% by weight of the total composition, wherein the soap base comprises ethanol in an amount of no greater than 5% by weight of the total composition.

29. The soap base according to claim 28, wherein the soap base comprises ethanol in an amount of no greater than 1% by weight of the total composition.

30. The soap base according to claim 28, wherein the soap base is substantially free of ethanol.

31. A process for the production of a soap comprising the steps of
(a) providing a soap base comprising:
(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) humectant in an amount of from 5 to 40% by weight of the total composition (b) heating the soap base to a temperature of from greater than 80° C. to less than 100° C., and
(c) cooling the heated soap base to provide the soap.

32. A soap product obtained or obtainable by the process of claim 31.

33. A soap product obtained or obtainable from a soap base as defined in claim 28.

34. A solid soap comprising,
(i) soap in an amount of from 20 to 50% by weight of the total composition,
(ii) water in an amount of from 8 to 40% by weight of the total composition,
(iii) sugar, sorbitol or a mixture thereof, wherein the combined amount of sugar and sorbitol is from 2 to 15% by weight of the total composition, and
(iv) humectant in an amount of from 5 to 40% by weight of the total composition.
wherein the soap comprises ethanol in an amount of no greater than 5% by weight of the total composition.

35. The soap according to claim 34, wherein the soap base comprises ethanol in an amount of no greater than 1% by weight of the total composition.

36. The soap according to claim 34, wherein the soap base is substantially free of ethanol.

37-39. (canceled)
